(19) United States
(12) Patent Application Publication
(10) Pub. No.: US 2016/0304684 A1
(43) Pub. Date: Oct. 20, 2016

(54) Method for Preparing Fiber-Reinforced Parts Based on Cyanate Ester/Epoxy Blends

(71) Applicant: LONZA LTD, Visp (CH)

(72) Inventors: Stefan Ellinger, Visp (CH); Gaetano La Delfa, Naters (CH); Marcel Sommer, Grenzach-Wyhlen (DE)

(21) Appl. No.: 15/101,295

(22) PCT Filed: Dec. 4, 2014
(86) PCT No.: PCT/EP2014/076566

§ 371 Date: Jun. 2, 2016

(30) Foreign Application Priority Data
Dec. 4, 2013 (EP) 13195613.8

(51) Int. Cl. C08J 5/24; B29C 70/44; B29C 70/52; B29C 45/02; B29C 45/00; C08J 5/04; B29C 70/86

(52) U.S. Cl. CPC C08J 5/24; C08J 5/043; C08J 5/042; B29C 70/443; B29C 70/86; B29C 45/02; B29C 45/0001; B29C 70/521; C08J 2363/02; C08J 2465/00; C08J 2463/02; C08J 2365/00; B29K 2049/00; B29K 2063/00

(57) ABSTRACT

The invention provides a method for preparing a fiber-reinforced part based on cyanate ester or a cyanate ester/epoxy blend, comprising the steps of (i) providing a liquid mixture comprising (a) from 15 to 99.9 wt. % of at least one di- or polyfunctional cyanate ester, (b) from 0 to 84.9 wt. % of at least one di- or polyfunctional epoxy resin, and (c) from 0.1 to 25 wt. % of a metal-free catalyst; (ii) providing a fiber structure (iii) placing said fiber structure in a mold or on a substrate, (iv) impregnating said fiber structore with said liquid mixture, (v) curing said liquid mixture by applying a temperature of 30 to 300° C. Using the method of the invention it is possible to produce in a short cycle time, using composite manufacturing processes such as resin transfer molding and infusion technology, fiber reinforced composite parts based on a cyanate ester or cyanate ester/epoxy resin formulation. The fiber-reinforced parts obtainable by the above method are also an object of the invention.

### FIELD OF THE INVENTION

The invention relates to a method for preparing fiber-reinforced parts based on cyanate ester/epoxy blends and to fiber-reinforced parts obtainable by said method.

### BACKGROUND OF THE INVENTION

There are several established methods for the production of fiber-reinforced parts based on thermoset resins. Newer methods, such as resin infusion, resin injection, filament winding, pultrusion and compression molding and further variants hereof can be technically and economically more efficient than the traditional prepregging. See e. g. Flake C. Campbell, Jr., Manufacturing Processes for Advanced Composites, Elsevier Ltd. 2004, ISBN 978-1-85617-415-2. These methods allow the utilization of carbon fiber reinforced plastic (CFRP) molds for the manufacturing of high performance composite materials. For small part production volumes, CFRP molds are much cheaper than steel or invar tooling. Invar tooling is usually required to provide beneficial thermal expansion to manufacture dimensionally stable materials. CFRP molds offer a thermal expansion coefficient similar to that of the parts manufactured using these molds, which eventually leads to better dimensional accuracy (Campbell, pp. 104-110, 336).

Today those materials generally are manufactured with prepreg materials, mainly based on carbon fiber reinforced epoxy resin systems. However, it is getting more and more common to utilize liquid epoxy resins systems for manufacturing CFRP molds by infusion, in some cases to utilize the same resin systems for mold manufacturing and for manufacturing the molded parts. Due to the curing cycles molds are thermally stressed, which results in decreasing interlaminar shear strength (ILSS) values of epoxy-based CFRP molds. It was therefore an object of the invention to provide a method for producing fiber-reinforced parts, such as CFRP molds, that withstand thermal stress for a long period of time without deteriorating their mechanical properties.

US 2011/0139496 A1 discloses resin compositions comprising a cyanate ester resin and a naphthylene ether type epoxy resin and, optionally, a curing accelerator. The cyanate ester resin content is preferably not more than 50% by mass. The resin compositions are used to produce adhesive films from solutions in solvents such as methyl ethyl ketone or solvent naphtha and the curing accelerators used include metal compounds such as zinc naphthenate or cobalt acetylacetonate. US 2011/0139496 A1 further mentions that its resin compositions could also be used to prepare prepregs, but such process would require either a solvent or high temperatures (“hot melt method”).

WO 2013/074259 A1 discloses polycyanate ester compositions containing silica nanoparticles. The preparation of the compositions involves a step wherein the polycyanate ester and the nanoparticles are dissolved or dispersed in a solvent, and a subsequent distillation in a wiped film evaporator. Even the solutions/dispersions before the distillation have a high viscosity of between about 10 Pa×s (10,000 mPa×s) and about 250 Pa×s at 72° C.

WO 2006/034830 A1 discloses a two-step process for the solvent-free preparation of a fiber-reinforced resin-coated sheet. In the first step a powdered resin, such as a (solid) cyanate ester or epoxy resin is applied to a substrate selected from a woven or non-woven fabric using magnetic and electrostatic forces, and in the second the thus obtained layer of coating powder is molted and cured. The process requires a system of magnetic and/or electrically charged rolls and it appears to be applicable to flat and preferably continuous substrates only.

### SUMMARY OF THE INVENTION

The invention provides a method for producing time-efficiently—meaning fast curing—fiber-reinforced parts based on cyanate esters or cyanate ester/epoxy blends using methods like resin transfer molding, vacuum assisted resin transfer molding, liquid resin infusion, Seemann Composites Resin Infusion Molding Process, vacuum assisted resin infusion, injection molding, compression molding, spray molding, laminating, filament winding, and pultrusion with a potentially high temperature resistance. With the formulations and the process parameters according to the invention it is possible to manufacture high-performing fiber reinforced composite parts as far as temperature resistance, mechanical properties and other characteristics are concerned.

### DETAILED DESCRIPTION OF THE INVENTION

According to the invention, a fiber-reinforced part based on cyanate ester or a cyanate ester/epoxy blend is prepared by a method comprising the steps of
(i) providing a liquid mixture comprising
   (a) from 15 to 99.9 wt. % of at least one di- or polyfunctional cyanate ester selected from the group consisting of difunctional cyanate esters of formula

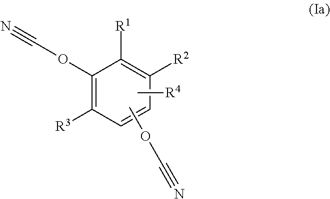

wherein R¹ through R⁴ are independently selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, halogenated C₃₋₈ cycloalkyl, C₁₋₁₀ alkoxy, halogen, phenyl and phenoxy,
difunctional cyanate esters of formula

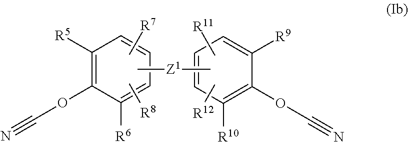

wherein R⁵ through R¹² are independently selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, halogenated C₃₋₈ cycloalkyl, C₁₋₁₀ alkoxy, halogen, phenyl and phenoxy;
and Z¹ indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(═CCl₂)—, —Si(CH₃)₂—, linear C₁₋₁₀ alkanediyl, branched C₄₋₁₀ alkanediyl, C₃₋₈ cycloalkanediyl, 1,2-phenylene, 1,3-phenylene, 1,4-phenylene, —N(R¹³)— wherein R¹³ is selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, phenyl and phenoxy, and moieties of formulas

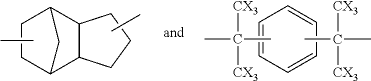

wherein X is hydrogen or fluorine;
and polyfunctional cyanate esters of formula

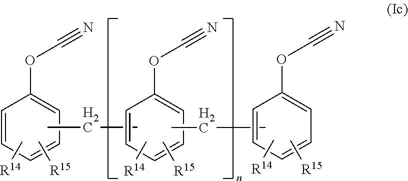

and oligomeric mixtures thereof, wherein n is an integer from 1 to 20 and R¹⁴ and R¹⁵ are independently selected from the group consisting of hydrogen, linear C₁₋₁₀ alkyl and branched C₄₋₁₀ alkyl;
(b) from 0 to 84.9 wt. % of at least one di- or polyfunctional epoxy resin selected from the group consisting of epoxy resins of formula

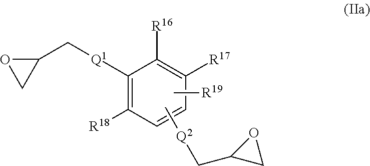

wherein Q¹ and Q² are independently oxygen or —N(G)- with G=oxiranylmethyl, and R¹⁶ through R¹⁹ are independently selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, halogenated C₃₋₈ cycloalkyl, C₁₋₁₀ alkoxy, halogen, phenyl and phenoxy;
epoxy resins of formula

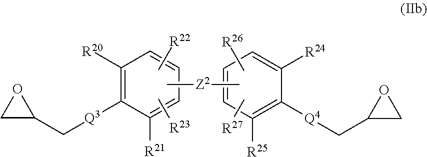

wherein Q³ and Q⁴ are independently oxygen or —N(G)- with G=oxiranyl-methyl, R²⁰ through R²⁷ are independently selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, halogenated C₃₋₈ cycloalkyl, C₁₋₁₀ alkoxy, halogen, phenyl and phenoxy, and Z² indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(═CCl₂)—, —Si(CH₃)₂—, linear C₁₋₁₀ alkanediyl, branched C₄₋₁₀ alkanediyl, C₃₋₈ cycloalkanediyl, 1,2-phenylene, 1,3-phenylene, 1,4-phenylene, glycidyloxyphenylmethylene and —N(R²⁸)— wherein R²⁸ is selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, phenyl and phenoxy;
epoxy resins of formula

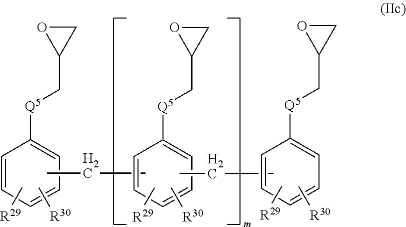

and oligomeric mixtures thereof, wherein m is an integer from 1 to 20, Q⁵ is oxygen or —N(G)- with G =oxiranylmethyl, and R²⁹ and R³⁰ are independently selected from the group consisting of hydrogen, linear C₁₋₁₀ alkyl and branched C₄₋₁₀ alkyl; and naphthalenediol diglycidyl ethers; and
(c) from 0.1 to 25 wt. % of a metal-free catalyst;
(ii) providing a fiber structure
(iii) placing said fiber structure in a mold or on a substrate,
(iv) impregnating said fiber structure with said liquid mixture, optionally by applying elevated pressure and/or evacuating the air from the mold and fiber structure, at a temperature of 20 to 80° C., and
(v) curing said liquid mixture by applying a temperature of 30 to 150° C. for a time sufficient to cure said mixture.

The expression “liquid mixture” means a mixture that is liquid at ambient temperature (typically about 25° C.) and has a viscosity of preferably less than 10,000 mPa×s at ambient temperature and preferably less than 1,000 mPa×s, more preferably less than 500 mPa×s, and most preferably no more than about 300 mPa×s at a temperature of 80° C. or less.

Here and hereinbelow, the expression “linear C₁₋₁₀ alkyl” includes all alkyl groups having 1 to 10 carbon atoms in an unbranched chain, irrespective of their point of attachment. Examples of C₁₋₁₀ alkyl groups are methyl, ethyl, 1-propyl, 2-propyl (isopropyl), 1-butyl (n-butyl), 2-butyl (sec-butyl), 1-pentyl, 2-pentyl, 3-pentyl, 1-hexyl, 2-hexyl, 3-hexyl and so on. Especially preferred linear C₁₋₁₀ alkyl groups are methyl, ethyl, 1-propyl, 2-propyl (isopropyl) and 1-butyl (n-butyl). Similarly, the expression “branched C₄₋₁₀ alkyl” includes all alkyl groups having 4 to 10 carbon atoms and at least one branching point. Examples of branched C₄₋₁₀ alkyl groups are 2-methyl-1-propyl (isobutyl), 2-methyl-2-propyl (tert-butyl), 3-methyl-1-butyl (isopentyl), 1,1-dimethyl-1-propyl (tert-pentyl), 2,2-dimethyl-1-propyl (neopentyl) and so on. Especially preferred branched C₄₋₁₀ alkyl groups are 2-methyl-1-propyl (isobutyl) and 2-methyl-2-propyl (tert-butyl). The expression “C₁₋₄ alkyl” includes methyl, ethyl, 1-propyl, 2-propyl (isopropyl), 1-butyl, 2-butyl (sec-butyl), 2-methylpropyl (isobutyl), and 2-methyl-2-propyl (tert-butyl) while the expressions “C₁₋₄ alkoxy” and “C₁₋₄ alkylthio” include the before mentioned C₁₋₄ alkyl groups bound via an oxygen or divalent sulfur atom. Particularly preferred “C₁₋₄ alkoxy” and “C₁₋₄ alkylthio” groups are methoxy and methylthio. The expression “C₃₋₈ cycloalkyl” includes saturated carbocyclic rings having 3 to 8 carbon atoms, in particular cyclopropyl, cyclobutyl, cyclopentyl, cycloheptyl and cyclooctyl. Especially preferred C₃₋₈ cycloalkyls are cyclopentyl, cyclohexyl and cycloheptyl.

The expressions “halogenated C₁₋₁₀ alkyl”, “halogenated branched C₄₋₁₀ alkyl” and “halogenated C₃₋₈ cycloalkyl” include any of the beforementioned groups bearing one or more halogen atoms selected from fluorine, chlorine, bromine and iodine at any position of the carbon chain or ring. Two or more halogen atoms may be equal or different.

The expression “C₁₋₁₀ alkoxy” includes any of the beforementioned linear C₁₋₁₀ alkyl or branched C₄₋₁₀ alkyl groups bound via an oxygen atom in an ether linkage, such as methoxy, ethoxy, 1-propoxy, 2-propoxy (isopropoxy), 1-butoxy and so on.

As mentioned above, the expression “halogen” includes fluorine, chlorine, bromine and iodine.

The expressions “linear C₁₋₁₀ alkanediyl”, “branched C₄₋₁₀ alkanediyl” and “C₃₋₈ cycloalkanediyl” include unbranched C₁₋₁₀ alkane chains, branched C₄₋₁₀ alkane chains and saturated carbocyclic rings having 3 to 8 carbon atoms, respectively, according to the above definitions of “linear C₁₋₁₀ alkyl”, “branched C₄-₁₀ alkyl” and “C₃₋₈ cycloalkyl”, having two open valencies at the same or different carbon atom(s). Examples of linear C₁₋₁₀ alkanediyl groups are methanediyl (methylene), 1,1-ethanediyl (ethylidene), 1,2-ethanediyl (ethylene), 1,3-propanediyl, 1,1-propanediyl (propylidene), 2,2-propane-diyl (isopropylidene), 1,4-butanediyl, 1,5-pentanediyl, 1,6-hexanediyl and so on. Examples of branched C₄₋₁₀ alkanediyl groups are 2-methyl-1,1-propanediyl (isobutylidene), 2-methyl-1,3-propanediyl and 2,2-dimethyl-1,3-propanediyl. Examples of C₃₋₈ cycloalkanediyl groups are 1,1-cyclopropanediyl, 1,2-cyclopropanediyl, 1,1-cyclo-butanediyl, 1,2-cyclobutanediyl, 1,3-cyclobutanediyl, 1,1-cyclopentanediyl, 1,2-cyclo-pentanediyl, 1,3-cyclopentanediyl, 1,1-cyclohexanediyl, 1,2-cyclohexanediyl, 1,3-cyclo-hexanediyl and 1,4-cyclohexanediyl. Cycloalkanediyl groups having the open valencies on different carbon atoms may occur in cis and trans isomeric forms.

Naphthalenediol diglycidyl ethers include the diglycidyl ethers of any naphthalenediol, such as 1,2-naphthalenediol, 1,3-naphthalenediol, 1,4-naphthalenediol, 1,5-naphthalenediol, 1,6-naphthalenediol, 1,7-naphthalenediol, 1,8-naphthalenediol, 2,3-naphthalenediol, 2,6-naphthalenediol and 2,7-naphthalenediol. Preferred are the diglycidyl ethers of the symmetric naphthalenediols, i.e., the 1,4-, 1,5-, 1,8-, 2,3-, 2,6- and 2,7-naphthalenediols. Especially preferred is the 2,6-naphthalenediol diglycidyl ether.

The polyfunctional cyanate esters (Ic) and polyfunctional epoxy resins (IIc) may be oligomeric mixtures of molecules having different values of n. Such oligomeric mixtures are usually characterized by an average value of n which may be a non-integer number.

In a preferred embodiment, the impregnation in step (iii) is achieved using a method selected from the group consisting of resin transfer molding, vacuum assisted resin transfer molding, liquid resin infusion, Seemann Composites Resin Infusion Molding Process, vacuum assisted resin infusion, injection molding, compression molding, spray molding, pultrusion, laminating, filament winding, Quickstep process or Roctool process. More preferably, the impregnation in step (iii) is achieved using a liquid composite molding process method selected from the group consisting of resin transfer molding, liquid resin infusion, Seemann Composites Resin Infusion Molding Process, vacuum assisted resin infusion, injection molding, and EADS vacuum assisted process (VAP®).

Pultrusion

For this method the state-of-the-art material are epoxy resins and polyesters. So far cyanate esters have not been applied to this method. The pultrusion process can be used to continuously manufacture bars and profiles with a regular cross-section or hollow structure. The fiber reinforcement is continuous and the fibers are aligned parallel to the production direction.

The reinforcement structures (made of glass or carbon or aramid fibers) are impregnated from a resin bath with all components mixed. The resin formulation should have a viscosity of less than 500 mPa×s and preferably no more than 300 mPa×s, at the impregnation temperature.

Complete and uniform impregnation of the reinforcing fibers is of crucial importance in the pultrusion process.

Subsequently, the composite material is fed into a heated die and drawn through it. As a result the matrix starts to polymerize in order to produce a fiber reinforced bar with a cross-section defined by the dimensions of the pultrusion die. Finally, the bar is cut to the required length.

By using aromatic diamines (especially Lonzacure™ DETDA80) as catalysts in the pultrusion process the mix viscosity can be further reduced, which helps to operate the resin bath at a lower temperature. In order to achieve a certain and economically production speed the concentration of the aromatic diamine needs to be higher. The higher concentration guarantees that the pultruded bar is already polymerized and solid on exiting the mold.

Gelation time and cure time can be designed very precisely and the curing time overall can be reduced considering the reactivity data given in the working examples below.

Filament Winding

For this method the state-of-the-art material are epoxy resins and polyesters. So far cyanate esters have only been applied rarely and without catalysts to this method. For the production of pressure vessels and convex geometries from composite materials, filament winding is one of the most competitive technologies. The industrially available impregnation method for the filament winding comprises the impregnation of the fibers in an open bath. During the impregnation process the roving has to be spread out in order to completely wet the single fiber filaments of the roving.

A filament winding apparatus then winds the tensioned and resin-impregnated fiber bundle around a mandrel which defines the shape and dimensions of the final product. The fiber bundles are applied under tension in order to achieve a high fiber/resin volume ratio on the composite.

For filament winding the resin formulation should have a viscosity of less than about 500 mPa×s, preferably no more than about 300 mPa×s, at the impregnation temperature. The reinforcement structures (made e. g. of glass, carbon, or aramid fibers) are impregnated in a resin bath with all components mixed. Complete and uniform impregnation of the reinforcing fibers is of crucial importance in the filament winding process.

By using aromatic diamines (especially Lonzacure™ DETDA80) as catalysts the mix viscosity can be further reduced, which helps to operate the resin bath at a lower temperature. In order to achieve a certain and economically curing process a certain concentration of the aromatic diamine is applied. The concentration guarantees that the produced (e. g. cylindrical or elliptical) part can be cured at much lower temperature than a pure cyanate ester resin (without catalyst) which results in lower internal stress and higher part quality.

Gelation time and cure time can be designed very precisely and the curing time overall can be reduced considering the reactivity data given in the working examples below.

The catalysts employed in the present invention are metal-free, and in particular free of transition metals which may impair the properties (e. g. the electromagnetic properties) of the final products or cause environmental or occupational problems. Preferably the liquid mixture of the present invention is essentially free of soluble metal compounds. “Essentially free” is to be understood to mean a metal content of no more than 10 ppm, preferably no more than 5 ppm by weight.

In a preferred embodiment the catalyst (c) is selected from the group consisting of aliphatic mono-, di- and polyamines, aromatic mono-, di- and polyamines, carbocyclic mono-, di and polyamines, heterocyclic mono-, di- and polyamines, compounds containing a five- or six-membered nitrogen-containing heterocyclic ring, hydroxy-amines, phosphines, phenols, and mixtures thereof.

Suitable catalysts include, without being limited thereto, phenols such as phenol, p-nitrophenol, nonylphenol, pyrocatechol, dihydroxynaphthalene; tertiary aliphatic amines such as trimethylamine, triethylamine, N,N-dimethyl-octylamine and tributyl-amine and their addition compounds such as N,N-dimethyl-octylamine-boron trichloride; cyclic tertiary amines such as diazabicyclo[2.2.2]octane, tertiary aromatic-aliphatic amines such as N,N-dimethylbenzylamine, aromatic nitrogen heterocycles such as imidazole, 1-methylimidazole, 2-methylimidazole, 2-ethylimidazole, 2-phenylimidazole, 2-ethyl-4-methylimidazole, 2-isopropylimidazole, 2-undecylimidazole, 2-octadecylimidazole, 2-phenylimidazole, 2-phenyl-4-methylimidazole, pyridine, pyridines substituted with one or more C₁₋₄ alkyl and/or C₁₋₄ alkenyl groups, N-methyl-piperazine, quinoline, isoquinoline and tetrahydroisoquinoline, quaternary and tertiary ammonium salts such as tetraethylammonium chloride and triethylamine hydrochloride, N-oxides such as pyridine-N-oxide, tertiary phosphines such as tributylphosphine and triphenylphosphine, aminoalcohols such as 2-dimethylaminoethanol, 1-methyl-2-dimethylaminoethanol, 1-(phenoxymethyl)-2-dimethylaminoethanol, 2-diethylamino-ethanol, 1-butoxymethyl-2-dimethylaminoethanol, nitrogen heterocycles with hydroxylated side chains such as 1-(2-hydroxy-3-phenoxypropyl)-2-methylimidazole, 1-(2-hydroxy-3-phenoxypropyl)-2-ethyl-4-methylimidazole, 1-(2-hydroxy-3-butoxypropyl)-2-methylimidazole, 1-(2-hydroxy-3-butoxypropyl)-2-ethyl-4-methylimidazole, 1-(2-hydroxy-3-phenoxypropyl)-2-phenylimidazoline, 1-(2-hydroxy-3-butoxypropyl)-2-methylimidazoline and N-(β-hydroxyethyl)morpholine, aminophenols such as 2-(dimethylaminomethyl)phenol and 2,4,6-tris(dimethylaminomethyl)phenol, diamines such as 2-dimethylaminoethylamine, 2-diethylaminoethylamine, 3-dimethylamino-n-propylamine and 3-diethylamino-n-propylamine, and mercapto compounds such as 2-dimethylaminoethanethiol, 2-mercaptobenzimidazole and 2-mercaptobenzothiazole, and other sulfur compounds such as methimazole (1-methyl-3H-imidazole-2-thione). All these catalysts can react with the cyanate ester resin and/or the epoxy resin and are thus covalently bound in the final product and not prone to leaching or diffusing out.

More preferably, the catalyst (c) is selected from the group consisting of aromatic diamines of formula

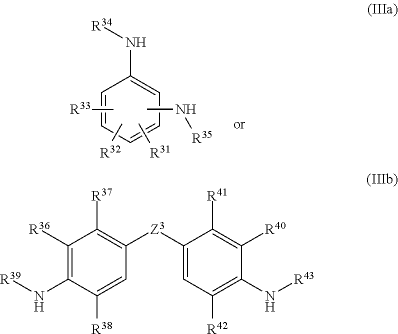

wherein R³¹, R³², R³³, R³⁶, R³⁶, R³⁷, R³⁸, R⁴⁰, R⁴¹ and R⁴² are independently selected from hydrogen, C₁₋₄ alkyl, C₁₋₄ alkoxy, C₁₋₄ alkylthio and chlorine and R³⁴, R³⁵, R³⁹ and R⁴³ are independently selected from hydrogen and C₁₋₈ alkyl, and mixtures thereof and Z³ indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(═CCl₂)—, —Si(CH₃)₂—, linear C₁₋₁₀ alkanediyl, branched C₄₋₁₀ alkanediyl, C₃₋₈ cycloalkanediyl, 1,2-phenylene, 1,3-phenylene, 1,4-phenylene, —N(R⁴⁴)— wherein R⁴⁴ is selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, phenyl and phenoxy.

In a preferred embodiment Z³ is a methylene (—CH₂—) group.

The expression “C₁₋₄ alkyl” is herein meant to include methyl, ethyl, 1-propyl, 2-propyl (isopropyl), 1-butyl, 2-butyl (sec-butyl), 2-methyl-1-propyl (isobutyl) and 2-methyl-2-propyl (tert-butyl) while the expression “C₁₋₈ alkyl” is meant to include the before-mentioned and all linear and branched alkyl groups having 5 to 8 carbon atoms according to the definitions given above for linear C₁₋₁₀ alkyl and branched C₄₋₁₀ alkyl.

In an especially preferred embodiment the catalyst (c) is selected from the group consisting of 3,5-diethyltoluene-2,4-diamine, 3,5-diethyltoluene-2,6-diamine, 4,4′-methylenebis(2,6-diisopropylaniline), 4,4′-methylenebis(2-isopropyl-6-methylaniline), 4,4′-methylenebis(2,6-diethylaniline), 4,4′-methylenebis(3-chloro-2,6-diethylaniline), 4,4′-methylenebis(2-ethyl-6-methylaniline), 4,4′-methylenebis(N-sec-butylaniline), and mixtures thereof.

In another preferred embodiment the at least one di- or polyfunctional cyanate ester (a) is a cyanate ester of formula (Ic) wherein R¹⁴ and R¹⁵ are hydrogen and the average value of n is from 1 to 20, more preferably from 1 to 15, even more preferably from 1 to 10, and most preferably from 1 to 5.

In still another preferred embodiment the at least one di- or polyfunctional epoxy resin (b) is selected from the group consisting of bisphenol A diglycidyl ether resins, bisphenol F diglycidyl ether resins, N,N,O-triglycidyl-3-aminophenol, N,N,O-triglycidyl-4-aminophenol, N,N,N′,N′-tetraglycidyl-4,4′-methylenebisbenzenamine, 4,4′,4″-methylidenetrisphenol triglycidyl ether resins, naphthalenediol diglycidyl ethers, and mixtures thereof.

In another preferred embodiment the liquid mixture obtained in step (i) comprises from 20 to 80 wt. % of the at least one di- or polyfunctional cyanate ester (a).

In another preferred embodiment the liquid mixture obtained in step (i) comprises from 20 to 79 wt. % of the at least one di- or polyfunctional epoxy resin (b).

In still another preferred embodiment the liquid mixture obtained in step (i) comprises from 0.5 to 10 wt. % of the catalyst (c).

In another preferred embodiment the fiber structure provided in step (ii) is selected from the group consisting of carbon fibers, glass fibers, quartz fibers, boron fibers, ceramic fibers, aramid fibers, polyester fibers, polyethylene fibers, natural fibers, and mixtures thereof.

In another preferred embodiment the fiber structure provided in step (ii) is selected from the group consisting of strands, yarns, rovings, unidirectional fabrics, 0/90° fabrics, woven fabrics, hybrid fabrics, multiaxial fabrics, chopped strand mats, tissues, braids, and combinations thereof.

The liquid mixture obtained in step (i) may contain one or more additional components selected from the group consisting of (internal) mold release agents, fillers, reactive diluents, and mixtures or combinations thereof.

Internal mold release agents are preferably present in amounts of 0 to 5 wt. %, based on the total amount of components (a), (b), and (c). Examples of suitable internal mold release agents to be added to the liquid mixture obtained in step (i) are Axel XP-I-PHPUL-1 (a proprietary synergistic blend of organic fatty acids, esters and amine neutralizing agent) and Axel MoldWiz® INT-1850HT (a proprietary synergistic blend of organic fatty acids, esters and alkanes and alkanols, supplier: Axel Plastics Research Laboratories, Inc., Woodside N.Y., USA). Other mold release agents are usually rubbed on a mold surface. Examples of those mold release agents are Frekote® 700-NC (a mixture of hydrotreated heavy naphtha (60-100%), dibutyl ether (10-30%), naphtha (petroleum) light alkylate (1-5%), octane (1-5%) and proprietary resin (1-5%); supplier: Henkel AG & Co. KGaA, Düsseldorf, Germany) and Airtech Release All® 45 (which contains 90-100% hydrotreated heavy naphtha (petroleum); supplier: Airtech Europe SARL, Differdange, Luxembourg).

Fillers are preferably present in amounts of 0 to 40 wt. %, based on the total amount of components (a), (b), and (c). They may be in particle, powder, sphere, chip and/or strand form in sized from nano scale to millimeters. Suitable fillers may be organic, such as thermoplastics and elastomers, or inorganic, such as glass, graphite, carbon fibers, silica, mineral powders, and the like.

Reactive diluents are preferably present in amounts of 0 to 20 wt. %, based on the amount of component (b). Examples of suitable reactive diluents are liquid mono-, di- or trifunctional epoxy compounds derived from aliphatic or cycloaliphatic alcohols or phenols, such as diglycidyl ethers of glycols, in particular 1,ω-alkanediols having 4 to 12 carbon atoms, for example 1,4-(diglycidyloxy)butane or 1,12-(diglycidyloxy)dodecane, or the diglycidyl ether of neopentyl glycol, glycidyl ethers of linear or branched primary alcohols having 8 to 16 carbon atoms, for example 2-ethylhexyl glycidyl ether or C₈₋₁₆ alkyl glycidyl ether, or the diglycidyl ether of 1,4-cyclohexanedimethanol.

In a preferred embodiment the liquid mixture obtained in step (i) contains little or no additional (non-reactive) solvent such as acetone or butanone. Preferably it contains less than 20 wt %, more preferably less than 15 wt. %, even more preferably less than 10 wt. % or 5 wt. %, each percentage being based on the total weight of components (a), (b), and (c), or, most preferably, no solvent at all.

The curing step (v) may be performed using any heating technique, including conventional techniques as well as innovative techniques such as Quickstep or Roctool processes. The time required for curing the liquid mixture depends on its composition and the curing temperature, it is typically in the range of about one hour to about 20 hours. A skilled person can easily determine suitable curing conditions based on the guidance given by the working examples below.

The curing step (v) may further be followed by a post-curing heat treatment, preferably at a temperature up to 300° C. for up to 10 hours.

The fiber-reinforced parts obtainable by the method of the invention exhibit a high-temperature resistance, as given by the T_{g} value (determined by tan δ measurement via TMA) of preferably more than 100° C., more preferably 120 to 160° C., after demolding and preferably more than 180° C., more preferably 200 to 420° C., after post-curing.

The fiber-reinforced parts obtainable by the method of the invention and its preferred embodiments as described above are likewise an object of the invention.

The fiber-reinforced parts obtainable by the method of the invention may be used in visible or non-visible application, including, but not limited to, fiber reinforced panels, such as protective covers, door and flooring panels, doors, stiffeners, spoilers, diffusors, boxes, etc., complex geometries, such as molded parts with ribs, parts with rotational symmetry parts such as pipes, cylinders, and tanks, in particular fuel tanks, oil and gas riser, exhaust pipes, etc., and massive or hollow profiles, such as stiffeners, spring leaves, carriers, etc., and sandwich-structured parts with or without core structure, such as blades, wings, etc., or carbon fiber-reinforced plastic molds for the manufacture of high performance composite materials.

The following non-limiting examples will illustrate the method of the invention and the preparation of the fiber-reinforced parts according to the invention. All percentages are by weight, unless specified otherwise.

### EXAMPLES

Methods:

RTM Resin Transfer Molding/Resin Injection

The process Resin Transfer Molding is described: The fiber reinforcement is placed in a mold set; the mold is closed and clamped. The resin is injected into the mold cavity under pressure. The motive force in RTM is pressure. Therefore, the pressure in the mold cavity will be higher than atmospheric pressure. In contrast, vacuum infusion methods use vacuum as the motive force, and the pressure in the mold cavity is lower than atmospheric pressure.

The resin injection molding process is designed for high output (short cycle time) part manufacturing under repetitive conditions, with very limited tolerances (concerning all process parameters, e.g. such as viscosity, mix ratio, permeability of the reinforcement, geltime, cycle time). It is most commonly used to process both thermoplastic and thermosetting polymers.

Desired Characteristic of the Resin used in RTM:
Must have a low viscosity at a certain temperature as it is held in the reservoir prior to injection
Must impregnate the fiber preform quickly and uniformly without voids
Must gel as quickly as possible once impregnation occurs (fast cycle time)
Must possess sufficient hardness to be demolded without distortion
Low viscosity critical (<1000 mPa×s at impregnation temperature to impregnate preform loading of 50%)
Low viscosity requires less pressure to achieve adequate fiber wetting
Injection temperature (typically elevated) of resin should be held as close as possible to minimum viscosity to ensure preform impregnation, since higher temperatures accelerate curing, thus cutting injection time.

The resin formulations developed (cyanate ester formulations and blends catalyzed with amines) can be also applied in composite manufacturing processes with dynamically changing mold temperatures, e.g. such as the Quickstep or Roctool processes.

Technical Characteristic:

Cyanate ester or cyanate ester/epoxy blends resin systems could be cured with the amines catalyst Lonzacure DETDA80 or other amines in RTM resin injection processes. The cure time could be designed varying the catalyst amount (for example from 0.5 to 5 wt. % or more) which depend mostly by the injection temperature and mold temperature applied for the process. Finally the cure cycle time could be reduced to values in the order of 5-30 minutes, preferably 5-20 minutes. Post-cure treatment between 180° C. and 300° C., preferably between 180° C. and 220° C., was applied in order to achieve the desired high thermal and mechanical performance.

### Example 1

The formulation was a mix of cyanate ester Primaset™ PT-30 (formula Ic, R¹⁴═R¹⁵═H, n=3-4) and bisphenol A epoxy resin (formula IIb, Q³=Q⁴=O, R²⁰═R²¹═R²²═R²³═R²⁴═R²⁵═R²⁶═R²⁷═H, Z²═—C(CH₃)₂—, glycidyloxy moieties in para position to Z²). The liquid amine Lonzacure™ DETDA80 (formula IIIa, R³¹═CH₃, R³²═R³³═C₂H₅, R³⁴═R³⁵═H, isomeric mixture of about 80% 3,5-diethyltoluene-2,4-diamine and about 20% 3,5-diethyltoluene-2,6-diamine) was used as catalyst.

A mixture of 12.80 g (41 wt. %) of Primaset™ PT-30 and 18.10 g (59 wt. %) of bisphenol A diglycidyl ether epoxy resin GY240 (Huntsman) was prepared. The viscosity of the resin system is shown in Table 1 below:

TABLE 1
Viscosity of Primaset ™ PT-30 (41 wt. %)/Bisphenol A (59 wt. %)

| Temperature [° C.] | Viscosity [mPa × s] |
|---|---|
| 40 | 3250 |
| 50 | 1000 |
| 60 | 400 |
| 80 | 100 |
| 100 | 37 |
| 120 | 18 |

The viscosity of the liquid catalyst amine Lonzacure™ DETDA80 is very low as shown in Table 2 below.

TABLE 2
Viscosity of Lonzacure ™ DETDA80

| Temperature [° C.] | Viscosity [mPa × s] |
|---|---|
| 25 | 176 |
| 30 | 108 |
| 40 | 46 |
| 50 | 24 |
| 60 | 14 |

The low viscosity and high fiber wetting potential of the resin system Primaset™ PT-30/−bisphenol A epoxy+catalyst Lonzacure™ DETDA80 can provide good processability parameters. The resin can be injected at temperatures between 50 and 80° C. with viscosities below 1000 mPa×s.

The resin system must gel as quickly as possible once the impregnation is completed. The gelation time can be controlled by varying the amount of catalyst and the temperature as shown in Table 3 below. The amount of catalyst is given in percent by weight, based on the amount of cyanate ester+epoxy resin.

TABLE 3
Gel Time (Gelnorm) of Primaset ™ PT-30/Bisphenol A Epoxy Resin +
Catalyst Lonzacure ™ DETDA80

| Catalyst | | | | | |
|---|---|---|---|---|---|
| Lonzacure ™ | Gel Time (Gelnorm) [min] | | | | |
| DETDA80 (%) | 60° C. | 80° C. | 100° C. | 120° C. | 140° C. |
| 1 | 1030 | 365 | 127 | 48 | 23 |
| 2 | 182 | 55 | 24.5 | 10 | 6.5 |
| 3 | 86 | 26 | 10 | 6 | n.d. |
| 5 | 39 | 14 | 6 | n.d. | n.d. |

n.d.: not determined (too short)

By setting a mold temperature of, for example, 130-140° C., the resin system containing from 2 to 3 wt. % amine Lonzacure™ DETDA80 catalyst achieved sufficient hardness within 5-20 min to allow demolding without distortion. Glass or carbon fiber composite parts could be produced by this method. A summary of the technical parameters is shown in Table 4 below.

TABLE 4
Summary of Technical Parameters for RTM-Resin Injection:

| Parameters | Values |
|---|---|
| Resin 1 (Primaset ™ PT-30) | 12.80 g (41 wt. %) |
| Resin 2 (Bisphenol A Epoxy GY240) | 18.10 g (59 wt. %) |
| Catalyst (Amine Lonzacure ™ DETDA80) | 2-3 wt. % |
| Fiber type | Glass or carbon fibers |
| Injection temperature | 50-80° C. |
| Viscosity at infusion temperature (80° C.) | <500 mPa × s |
| Mold temperature | 130-140° C. |
| Mold cure cycle | 5-20 min @ 130-140° C. |

After the cure cycle it was possible to demold the parts without distortion.

High temperature resistance (respectively a high T_{g}) can be achieved either through a defined post-cure process step in an oven (temperature between 180° C. and 220° C.) or during service in a high temperature environment.

The T_{g} glass transition temperature was measured by Thermal Mechanical Analysis (TMA). The machine used was a Mettler Toledo instrument TMA SDTA840. The sample dimensions were 6×6 mm² (length×width) and 1.5 mm thickness. The test method applied two heating ramps (first ramp: 25-220° C. @ 10 K/min and a second ramp 25-350° C. @ 10 K/min). The T_{g} was evaluated on the second ramp. The results are shown in Table 5 below.

TABLE 5
Thermal Performance (Example 1)

| | |
|---|---|
| Cure cycle | 10 min @ 120° C. + Demold |
| Post cure cycle | 25-220° C. @ 1 K/min + 2 h @ 220° C. |
| T_{g} onset by TMA | 225-235° C. |

### Example 2

The formulation was a mix of cyanate ester Primaset™ PT-15 (formula Ic, R¹⁴═R¹⁵═H, n=2-3) and bisphenol A diglycidyl ether epoxy resin. The liquid amine Lonzacure™ DETDA80 was used as catalyst.

A mixture of 12.80 g (41 wt. %) of Primaset™ PT-15 and 18.10 g (59 wt. %) of bisphenol A epoxy resin GY240 (Huntsman) was prepared. The viscosity of the resin system is shown in Table 6 below:

TABLE 6
Viscosity of Primaset ™ PT-15/Bisphenol A Epoxy Resin

| Temperature [° C.] | Viscosity [mPa × s] |
|---|---|
| 30 | 2100 |
| 40 | 650 |
| 50 | 250 |
| 60 | 120 |
| 80 | 40 |
| 100 | 17 |
| 120 | 10 |

The low viscosity and high fiber wetting potential of the resin system Primaset™ PT-15/bisphenol A epoxy resin+catalyst amine Lonzacure™ DETDA80 provide even better processability parameters than the resin system described above in Example 1. The resin can be injected at temperatures between 35 and 60° C. with viscosity lower than 1000 mPa×s.

The resin system must gel as quickly as possible once the impregnation is completed. The gelation time can be controlled by varying the amount of catalyst and the temperature as can be shown in Table 7 below:

TABLE 7
Gel Time (Gelnorm) of Primaset ™ PT-15 (41 wt. %)/Bisphenol A Epoxy
(59 wt. %) resin + catalyst Lonzacure ™ DETDA80

| Catalyst | | | | | |
|---|---|---|---|---|---|
| Lonzacure ™ | Geltime (Gelnorm) [min] | | | | |
| DETDA80 (%) | 60° C. | 80° C. | 100° C. | 120° C. | 140° C. |
| 1 | 2056 | 612 | 233 | 97 | 42 |
| 2 | 403 | 151 | 54 | 23 | 10 |
| 3 | 183 | 61 | 23 | 9 | 5.5 |
| 5 | 81 | 22 | 8.5 | 5 | 3 |

By, for example, setting the mold temperature to 120° C., the resin system containing from 3 to 5 wt. % amine Lonzacure™ DETDA80 catalyst achieves sufficient hardness to allow demolding after about 10 min without distortion. Glass or carbon fiber composite parts could be produced by this method. A summary of the technical parameters is shown in Table 8 below.

TABLE 8
Summary of the technical parameters RTM-resin injection:

| Parameters | Values |
|---|---|
| Resin 1: Primaset ™ PT-15 | 12.80 g |
| Resin 2: Bisphenol A epoxy GY240 | 18.10 g |
| Catalyst: Amine Lonzacure ™ DETDA80 | 3-5 wt. % |
| Fiber type | Glass or carbon fibers |
| Injection temperature | 35-60° C. |
| Viscosity at infusion temperature (80° C.) | <500 mPa × s |
| Mold Temperature | 120-140° C. |
| Mold Cure cycle | 5-15 min @ 120-140° C. |

After the cure cycle it was possible to demold the parts without distortion.

High temperature resistance (respectively a high T_{g}) can be achieved either through a defined post-cure process step in an oven (temperature between 180° C. and 220° C.) or during service in a high temperature environment.

The T_{g} glass transition temperature was measured by Thermal Mechanical Analysis (TMA) as described in Example 1. The results are shown in Table 9 below:

TABLE 9
Thermal Performance (Example 2)

| | |
|---|---|
| Cure cycle | 10 min @ 120° C. + Demold |
| Post cure cycle | 25-220° C. @ 1 K/min + 2 h @ 220° C. |
| T_{g} onset by TMA | 205-215° C. |

Vacuum Assisted Resin Transfer Molding (VARTM) and Resin Infusion

Former inventions were mostly addressing the prepreg technology or 1-component resin formulations. Resin infusion requires resin systems with a viscosity (at infusion temperature) of less than 500 mPa×s, preferably less than 300 mPa×s. The reinforcement structures (made of glass or carbon or aramid fibers) are impregnated from a resin pot with all components mixed. By using aromatic diamines (especially Lonzacure™ DETDA80) the mix viscosity can be further reduced, which helps to operate the resin pot at a lower temperature. Considering the size of the part, the infusion time must be evaluated. Gelation time and cure time can be designed very precisely and the curing time overall can be reduced considering the reactivity date in Table 10 below.

TABLE 10
Gel Time (Gelnorm) of Primaset ™ PT-30/Bisphenol A Epoxy Resin +
Catalyst Lonzacure ™ DETDA80

| Catalyst | | | | | | |
|---|---|---|---|---|---|---|
| Lonzacure ™ | Geltime (Gelnorm) [min] | | | | | |
| DETDA80 (%) | 60° C. | 80° C. | 100° C. | 120° C. | 130° C. | 140° C. |
| 0.5 | | 1208 | 388 | 136 | 98 | 61 |
| 1 | 1009 | 339 | 125 | 46 | 32 | 22 |
| 2 | 160 | 64 | 23 | 6.5 | 5 | n.d. |
| 5 | 18 | 7 | n.d. | n.d. | n.d. | n.d. |
| 10 | 8 | n.d. | n.d. | n.d. | n.d. | n.d. |

n.d.: not determined (too short)

The viscosity of the blend Primaset™ PT-30 (68 wt. %)/Bisphenol A Epoxy (32 wt. %) resin system is shown in Table 11 below:

TABLE 11
Viscosity of Primaset ™ PT-30/Bisphenol A Epoxy

| Temperature [° C.] | Viscosity [mPa × s] |
|---|---|
| 30 | 54400 |
| 40 | 9400 |
| 60 | 830 |
| 80 | 165 |
| 100 | 59 |
| 120 | 25 |

### Example3

Vacuum Assisted Resin Transfer Molding (VARTM) and Resin Infusion:

Technical Characteristic:

A flat glass mold was used. The mold was cleaned, and the surface was rubbed with a mold release agent. In this test, the liquid release agent Release All® 45 from Airtech was used.

The carbon fiber fabric was cut into 25×25 cm² pieces and care was taken to prevent fiber pullout during handling of the cut plies. 16 plies were cut for each of the experimental laminates. In the test case, the carbon fabric fibers used were Toho Tenax HTA40 E13 (supplier: Toho Tenax Europe GmbH, Wuppertal, Germany). Then the carbon fiber fabric layers prepared were laid on the mold surface. Care was taken to build up a symmetric lay-up in order to prevent distortion during the post-cure stage.

In this example, an Airtech Omega Flow Line was used for both the resin feed and the vacuum line. The dimension of the Omega Flow Line was the same as the width of the carbon fiber layers on both sides (resin feed inlet and vacuum line outlet). Once the resin was infiltrated on one side, the resin feed line was filled on its complete length very quickly. After that, the resin infused across the whole carbon laminate lay-up toward the vacuum outlet.

The following resin infusion auxiliary materials were utilized: An “all-in-one” peel ply and release film layer (Fibertex Compoflex® SB150) was cut and placed directly in contact over the carbon fiber layers. A resin distribution medium layer (Airtech Knitflow 105 HT) was cut and installed on the top of the previous layup (carbon fibers and peel ply/release film layers). The resin distribution medium allowed the spreading of the resin quickly in the whole composite part. The distribution layer was positioned as well as a basement of the Omega Flow Line (Airtech Omega Flow Lines OF750) for the resin feed inlet. On the other side of the mold (vacuum line outlet), a resin distribution layer and a Compoflex® SB150 (Fibertex Nonwovens A/S, Aalborg, Denmark) layer were placed as a basement for the Omega Row Line. All layers of material in contact with the mold were compressed to avoid “bridging” when vacuum was applied. High temperature resin infusion connectors (Airtech VAC-RIC-HT or RIC-HT) were attached to the middle of the resin feed inlet and vacuum outlet channels.

A customized rectangular vacuum bag was used which was heat seamed at three sides of its perimeter and specially designed for the mold dimension (Airtech Wrightlon® WL5400 or WL7400). All the infusion assembly was set up inside the vacuum bag which was finally heat seamed on the one open side of its perimeter. Two small holes were punctured in the bag. The feed line and vacuum line connectors were attached to the bag over the holes and nylon tubes were installed. The assembled mold was connected with a resin source and a vacuum pump.

The whole mold assembly was installed inside an oven to infuse at the required temperature. Full vacuum and temperature was applied to the bag assembly for 3 up to 12 hours before infusion was started. It was beneficial to apply to the fiber lay-up and mold assembly the processing temperature conditions in order to improve the flow process and to remove the moisture picked-up from the fiber layers.

The vacuum pump was turned-on with a vacuum of 3-5 hPa, and excellent sealing was achieved by checking leakages. The oven temperature was increased to 80° C. at a heating rate of 3-5 K/min.

350 g of the Primaset™ PT-30/Bisphenol A diglycidyl ether epoxy resin blend (a mix of 238 g cyanate ester Primaset™ PT-30 and 112 g bisphenol A epoxy resin (Huntsman GY240)) was placed inside a vacuum oven at 80° C. and degassed at 3 hPa for 30 min to remove any air bubbles present in the resin. Then the amine catalyst Lonzacure™ DETDA80 (3.15 g, 0.9 wt %) was added at 80° C. and mixed till complete homogenization. The resin+amine catalyst system was placed in an oven at 80° C. and degassed again at 5 hPa for 5-10 minutes to remove any air bubbles created during the mixing with the catalyst.

The vacuum bag pressure was set to 10 mbar and the oven temperature was 80° C. Heating the resin to 80° C. reduced the viscosity to the range of 150-300 mPa×s. At this viscosity, the Primaset™ PT-30/bisphenol A diglycidyl ether epoxy resin blend+amine catalyst Lonzacure™ DETDA could be successfully infused within 20-30 minutes and made to flow through the fibers under the bag.

The full vacuum of 10 hPa was kept till the resin reached cure point. The material was cured under the bagging assembly using the following cure cycle:

80° C.-120° C., 1 K/min; 2 h @ 120° C.; 120 ° C-140° C., 1 K/min; 2 h @ 140° C.

After curing the material could be easily demolded from the bagging assembly. A post cure cycle can be applied as follows, in order to reach the mechanical and thermal performances desired: 25° C.-220° C., 0.5 K/min, 2 h @ 220° C.

A summary of the technical parameters is shown in Table 12 below.

TABLE 12
Summary of the technical parameters of resin infusion:

| Parameters | Values |
|---|---|
| Resin 1 (Primaset ™ PT-30) | 238 g |
| Resin 2 (Bisphenol A Epoxy | 112 g |
| (GY240)) | |
| Catalyst (Liquid Amine | 3.15 g (0.9 wt. %) |
| Lonzacure ™ DETDA80) | |
| Fiber (carbon fiber fabric) | Toho Tenax HTA40 E13 carbon, |
| | 285 g/m² |
| Fiber layup number | 16 |
| Degassing-time/temperature/ | 30 min/80° C./3 hPa |
| pressure (Resin) | |
| Degassing-time/temperature/ | 5-10 min/80° C./5 hPa |
| pressure (Resin + catalyst) | |
| Infusion temperature/mold | 80° C./80° C. |
| temperature | |
| Viscosity at infusion | 160-200 mPa × s |
| temperature (80° C.) | |
| Infusion pressure/infusion | 10 mbar/20-40 min |
| time | |
| Cure cycle after resin infusion | 80° C.-120° C., 1 K/min; 2 h @ 120° C.; |
| completed | 120° C.-140° C., 1 K/min |
| Demold from bagging | — |
| assembly | |
| Post-cure cycle | 25° C.-220° C., 0.5 K/min, 2 h @ 220° C. |

The T_{g} glass transition temperature was measured by Thermal Mechanical Analysis to (TMA) as described in Example 1. The result is shown in Table 13 below:

TABLE 13
Thermal Properties (Example 3)

| | |
|---|---|
| Post cure cycle | 25-220° C. @ 0.5 K/min + 2 h @ 220° C. |
| T_{g} onset by TMA | 280-290° C. |

### Example 4

Pultrusion:

Technical Characteristic:

A rectangular metal pultrusion mold was used, that formed a composite profile of 20×10 mm². The mold was cleaned, and the surface was rubbed with a mold release agent (Chemlease® IC25).

The fiber reinforcement (carbon fiber Toho Tenax HTA (supplier: Toho Tenax Europe GmbH, Wuppertal, Germany)) was formed by 16 rovings. The fibers were directly pulled from the bobbin towards the resin bath.

The impregnated fibers entered the pultrusion mold and were pulled through the mold. The mold comprised four differently controlled heating zones, starting with a temperature of 150° C. and increasing to 160° C., 170° C. and finally 180° C. at the mold outlet.

A Primaset™ PT-30/bisphenol A diglycidyl ether epoxy resin blend (350 g, mix of 238 g cyanate ester Primaset™ PT-30 and 112 g bisphenol A epoxy resin (Huntsman GY240)) was mixed with 2% (7 g) of an internal mold release (Chemlease IC25, supplier: Chemtrend). Then the amine catalyst Lonzacure™ DETDA80 (8.75 g, 2.5 wt. %) was added at 80° C. and mixed till complete homogenization. The resin+amine catalyst system was placed into the resin bath which was kept at a constant temperature of 65° C. Then the pultrusion process started as described. Finally a post cure cycle can be was applied: 25→220° C. @ 1 K/min+2 h @ 220° C.

The production speed achieved was 0.2 m/min. The samples manufactured showed a T_{g} (by DMA) of 80° C. after molding and 300° C. after postcure.

A summary of the technical parameters is shown in Table 14 below.

TABLE 14
Summary of the technical parameters of pultrusion:

| Parameters | Values |
|---|---|
| Resin 1 (Primaset ™ PT-30) | 238 g |
| Resin 2 (Bisphenol A Epoxy (GY240)) | 112 g |
| Catalyst (Liquid Amine | 8.75 g (2.5 wt. %) |
| Lonzacure ™ DETDA80 | |
| Internal mold release (Chemtrend | 7 g (2.0 wt. %) |
| Chemlease ® IC25) | |
| Fiber (carbon fiber rovings) | Toho Tenax HTA 16 rovings |
| Mixing temperature | 80° C. |
| Impregnation bath temperature | 65° C. |
| Mold temperatures (4 heating sections) | 150° C., 160° C., 170° C., |
| | 180° C. |
| Viscosity after mixing (80° C.) | 120-200 mPa × s |
| Production speed | 0.15-0.22 m/min |
| Post-cure cycle | 25° C.→220° C., 1 K/min, |
| | 2 h @ 220° C. |

The T_{g} glass transition temperature was measured by Thermal Mechanical Analysis (TMA) as described in Example 1. The result is shown in Table 17 below:

TABLE 15
Thermal Properties (Example 4)

| | |
|---|---|
| Post cure cycle | 25-220° C. @ 0.5 K/min + 2 h @ 220° C. |
| T_{g} onset by TMA | 250-265° C. |

### Example 5

Filament Winding:

Technical Characteristic:

A cylindrical mandrel was used to form a composite pipe with an inner diameter of 40 mm. The mandrel was cleaned, and the surface was rubbed with a mold release agent.

The fiber reinforcement (carbon fiber Toho Tenax HTA (supplier: Toho Tenax Europe GmbH, Wuppertal, Germany)) was formed by 4 rovings. The fibers were directly pulled from the bobbin through the resin bath which was kept at a constant temperature of 65° C. The impregnated fibers were placed on the mandrel in different angles of ±30° and 89° to form 18 layers, resulting in a pipe wall thickness of 4.4 mm.

The mandrel and the impregnated fibers placed hereon were kept at a constant temperature of 80° C.

A resin blend of Primaset™ PT-30 cyanate ester and bisphenol A diglycidyl ether epoxy resin (350 g, a mix of 238 g Primaset™ PT-30 and 112 g bisphenol A epoxy resin (Huntsman GY240)) was mixed with the amine catalyst Lonzacure™ DETDA80 (7 g, 2 wt %) at 70° C. complete homogenization. The resin+amine catalyst system was placed into the resin bath at 65° C. Then the filament winding process started as described, followed by a precure cycle at 80° C. for 24 h, cooling to ambient temperature (cooling rate 1 K/min), and demolding from the mandrel at ambient. Finally, the pipe was subjected to a postcure treatment at 25° C.→220° C., 1 K/min and 2 h @ 220° C.

A summary of the technical parameters is shown in Table 16 below.

TABLE 16
Summary of the technical parameters by filament winding:

| Parameters | Values |
|---|---|
| Resin 1 (Primaset ™ PT-30) | 238 g |
| Resin 2 (Bisphenol A Epoxy (GY240)) | 112 g |
| Catalyst (Liquid Amine | 7 g (2.0 wt. %) |
| Lonzacure ™ DETDA80 | |
| Fiber (carbon fiber rovings) | Toho Tenax HTA 4 rovings |
| Mixing temperature | 80° C. |
| Impregnation bath temperature | 65° C. |
| Viscosity at impregnation | <500 mPa × s |
| temperature (65° C.) | |
| Production speed (fiber speed) | 10-18 m/min |
| Pipe dimensions | Inner diameter: 40 mm, |
| | Outer diameter: 48.8 mm |
| Precure | 24 h @ 80° C. |
| Post-cure cycle | 25° C.→220° C., 1 K/min, |
| | 2 h @ 220° C. |

The T_{g} glass transition temperature was measured by Thermal Mechanical Analysis (TMA) as described in Example 1. The result is shown in Table 17 below:

TABLE 17
Thermal Properties (Example 5)

| | |
|---|---|
| Post cure cycle | 25-220° C. @ 1 K/min + 2 h @ 220° C. |
| T_{g} onset by TMA | 240-260° C. |

### Examples 6-14

Primaset™ PT-30 cyanate resin was tested with various catalysts. The samples were prepared by heating the resin to 95° C., the adding the catalyst and mixing till complete homogenization.

The samples were subjected to a curing cycle comprising heating from 25° C. to 140° C. at 1 K/min and keeping at 140° C. for 30 min, followed by a post curing treatment comprising heating from 25° C. to 200° C. at 1 K/min, keeping at 200° C. for 1 h, heating from 200° C. to 260° C. at 1 K/min, and keeping at 260° C. for 1 h.

The T_{g} glass transition temperature was measured by Thermal Mechanical Analysis (TMA) as described above. The test method applied two heating ramps (first ramp: 25-250° C. @ 10 K/min, second ramp: 25-400° C. @ 10 K/min). The T_{g} was evaluated on the second ramp. The results are compiled in Table 18, together with the methods suitable for preparing fiber-reinforced parts from each composition.

TABLE 18

| | Catalyst | | | | Methods |
|---|---|---|---|---|---|
| Example No | Name | Amount | Gel Time @ 140° C. | T_{g} Onset [° C.] | (Example Nos.) |
| 6 | Lonzacure ™ | 3 wt. % | 11 min | >300 | 1, 2 |
| | M-CDEA | | | | |
| 7 | Lonzacure ™ | 2 wt. % | 13 min | 260-270 | 1, 2 |
| | M-DEA | | | | |
| 8 | Albemarle | 2 wt. % | 17 min | 280-290 | 1, 2, 3, 4, 5 |
| | Ethacure ® 300¹⁾ | | | | |
| 9 | Albemarle | 4 wt. % | 19 min | 280-290 | 1, 2, 3, 4, 5 |
| | Ethacure ® 420²⁾ | | | | |
| 10 | OMICURE ™ | 2 wt. % | 4 min | >300 | 1, 5 |
| | BC-120³⁾ | | | | |
| 11 | 2-Ethyl-4-methyl- | 5 wt. % | 17 min | 260-265 | 1, 5 |
| | imidazole | | | | |
| 12 | 2-Ethylimidazole | 5 wt. % | 25 min | 270-280 | 1, 2 |
| 13 | Alkylpyridine | 5 wt. % | 17 min | 280-290 | 1, 5 |
| | mixture⁴⁾ | | | | |
| 14 | Lonzacure ™ | 1.5 wt. % | 9 min | >300 | 1, 2, 3, 4, 5 |
| | DETDA 80 | | | | |

¹⁾Mixture of 3,5-bis(methylthio)toluene-2,4-diamine and 3,5-bis(methylthio)toluene-2,6-diamine
²⁾4,4′-Methylenebis-(N-sec-butylaniline)
³⁾N,N-Dimethyl-n-octylamine, boron trichloride complex
⁴⁾Mixture of alkyl- and alkenylpyridines, comprising ca. 40% 5-(2-butenyl)-2-methyl-pyridines (cisitrans mixture, ratio about 1:3), ca. 12% 2-allyl-5-ethylpyridine, ca. 9% 3,5-diethyl-2-methylpyridine, ca. 6% 5-ethyl-2-propylpyridine

### Examples 15-28

A blend of Primaset™ PT-30 cyanate resin and bisphenol A diglycidyl ether epoxy resin was tested with various catalysts. The samples were prepared by heating the resins to 95° C., the adding the catalyst and mixing till complete homogenization.

The samples were subjected to a curing cycle comprising heating from 25° C. to 140° C. at 1 K/min and keeping at 140° C. for 30 min, followed by a post curing treatment comprising heating from 25° C. to 220° C. at 1 K/min and keeping at 220° C. for 2 h.

The T_{g} glass transition temperature was measured by Thermal Mechanical Analysis (TMA) as described above. The test method applied two heating ramps (first ramp: 25→200° C. @ 10 K/min, second ramp: 25-350° C. @ 10 K/min). The T_{g} was evaluated on the second ramp. The results are compiled in Table 19, together with the methods suitable for preparing fiber-reinforced parts from each composition.

TABLE 19

| | Catalyst | | | | Methods |
|---|---|---|---|---|---|
| Example No | Name | Amount | Gel Time @ 140° C. | T_{g} Onset [° C.] | (Example Nos.) |
| 15 | Lonzacure ™ | 3 wt. % | 14 min | 270-280 | 1, 2 |
| | M-CDEA | | | | |
| 16 | Lonzacure ™ | 2 wt. % | 9 min | 275-285 | 1, 2 |
| | M-DEA | | | | |
| 17 | Albemarle | 2 wt. % | 18 min | 260-270 | 1, 2, 3, 4, 5 |
| | Ethacure ® 300¹⁾ | | | | |
| 18 | Albemarle | 3 wt. % | 12 min | 260-270 | 1, 2, 3, 4, 5 |
| | Ethacure ® 420²⁾ | | | | |
| 19 | N,N-Dimethyl- | 3 wt. % | 6 min | 190-200 | 1, 2 |
| | benzylamine | | | | |
| 20 | 2,4,6-Tris(dimethyl- | 3 wt. % | 12 min | 280-290 | 1, 2 |
| | aminomethyl)phenol | | | | |
| 21 | OMICURE ™ | 3 wt. % | 5 min | 180-190 | 1, 5 |
| | BC-120³⁾ | | | | |
| 22 | 2-Ethyl-4-methyl- | 3 wt. % | 15 min | 190-200 | 1, 5 |
| | imidazole | | | | |
| 23 | 2-Ethylimidazole | 3 wt. % | 12 min | 200-205 | 1, 2 |
| 24 | 5-Ethyl-2-methyl- | 2 wt. % | 9 min | 250-260 | 1, 5 |
| | pyridine | | | | |
| 25 | Alkylpyridine | 2 wt. % | 13 min | 240-250 | 1, 5 |
| | mixture⁴⁾ | | | | |
| 26 | Niacinamide | 2 wt. % | 11 min | 240-250 | 1, 2 |
| 27 | 1-Butyl-3-methyl- | 5 wt. % | 28 min | 190-200 | 1, 5 |
| | pyridinium | | | | |
| | dicyanoamide | | | | |
| 28 | Lonzacure ™ | 1.5 wt. % | 9 min | 270-280 | 1, 2, 3, 4, 5 |
| | DETDA 80 | | | | |

¹⁾Mixture of 3,5-bis(methylthio)toluene-2,4-diamine and 3,5-bis(methylthio)toluene-2,6-diamine
²⁾4,4′-Methylenebis-(N-sec-butylaniline)
³⁾N,N-Dimethyl-n-octylamine, boron trichloride complex
⁴⁾Mixture of alkyl- and alkenylpyridines, comprising ca. 40% 5-(2-butenyl)-2-methyl-pyridines (cisitrans mixture, ratio about 1:3), ca. 12% 2-allyl-5-ethylpyridine, ca. 9% 3,5-diethyl-2-methylpyridine, ca. 6% 5-ethyl-2-propylpyridine

1. A method for preparing a fiber-reinforced part based on cyanate ester or a cyanate ester/epoxy blend, comprising the steps of
(i) providing a liquid mixture comprising
(a) from 15 to 99.9 wt. % of at least one di- or polyfunctional cyanate ester selected from the group consisting of difunctional cyanate esters of formula 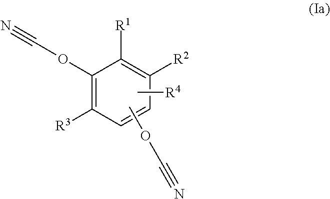
wherein R¹ through R⁴ are independently selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, halogenated C₃₋₈ cycloalkyl, C₁₋₁₀ alkoxy, halogen, phenyl and phenoxy, difunctional cyanate esters of formula 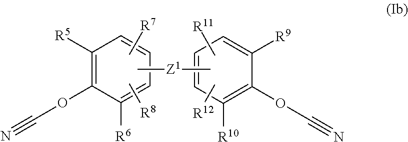
wherein R⁵ through R¹² are independently selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, halogenated C₃₋₈ cycloalkyl, C₁₋₁₀ alkoxy, halogen, phenyl and phenoxy;
and Z¹ indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(═CCl₂)—, —Si(CH₃)₂—, linear C₁₋₁₀ alkanediyl, branched C₄₋₁₀ alkanediyl, C₃₋₈ cycloalkanediyl, 1,2-phenylene, 1,3-phenylene, 1,4-phenylene, —N(R¹³)— wherein R¹³ is selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, phenyl and phenoxy, and moieties of formulas 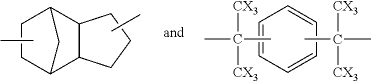
wherein X is hydrogen or fluorine;
and polyfunctional cyanate esters of formula 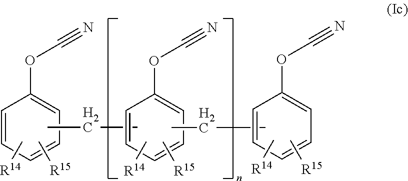
and oligomeric mixtures thereof, wherein n is an integer from 1 to 20 and R¹⁴ and R¹⁵ are independently selected from the group consisting of hydrogen, linear C₁₋₁₀ alkyl and branched C₄₋₁₀ alkyl:
(b) from 0 to 84.9 wt. % of at least one di- or polyfunctional epoxy resin selected from the group consisting of epoxy resins of formula 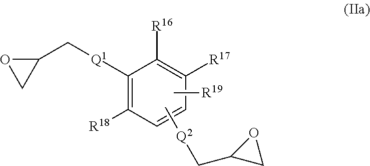
wherein Q¹ and Q² are independently oxygen or —N(_{G})- with G=oxiranylmethyl, and R¹⁶ through R¹⁹ are independently selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, halogenated C₃₋₈ cycloalkyl, C₁₋₁₀ alkoxy, halogen, phenyl and phenoxy;
epoxy resins of formula 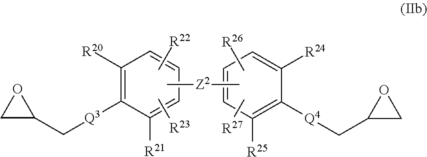
wherein Q³ and Q⁴ are independently oxygen or —N(G)- with G=oxiranylmethyl, R²⁰ through R²⁷ are independently selected from the group consisting of hydrogen, linear C₁₋₁₀ alkyl, halogenated linear C₁₋₁₀ alkyl, branched C₄₋₁₀ alkyl, halogenated branched C.₄₋₁₀ alkyl, C₃₋₈ cycloalkyl, halogenated C₃₋₈ cycloalkyl, C₁₋₁₀ alkoxy, halogen, phenyl and phenoxy, and Z² indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(CCl₂)—, —Si(CH₃)₂—, linear C₁₋₁₀ alkanediyl, branched C₄₋₁₀ alkanediyl, C₃₋₈ cycloalkanediyl, 1,2-phenylene, 1,3-phenylene, 1,4-phenylene, glycidyloxyphenylmethylene, and —N(R²⁸)- wherein R²⁸ is selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, phenyl and phenoxy;
epoxy resins of formula 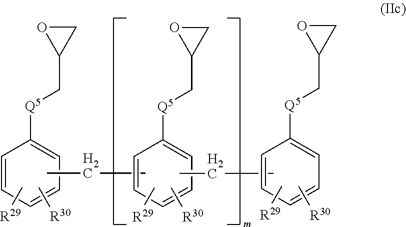
and oligomeric mixtures thereof, wherein m is an integer from 1 to 20, Q⁵ is oxygen or —N(G)- with G=oxiranylmethyl, and R²⁹ and R³⁰ are independently selected from the group consisting of hydrogen, linear C₁₋₁₀ alkyl and branched C₄₋₁₀ alkyl; and naphthalenediol diglycidyl ethers; and
(c) from 0.1 to 25 wt % of a metal-free catalyst;
wherein the percentages of (a), (b) and (c) are based on the total amount of (a), (b) and (c);
(ii) providing a fiber structure
(iii) placing said fiber structure in a mold or on a substrate,
(iv) impregnating said fiber structure with said liquid mixture, optionally by applying elevated pressure and/or evacuating the air from the mold and fiber structure, at a temperature of 20 to 80° C., and
(v) curing said liquid mixture by applying a temperature of 30 to 300° C., preferably 30 to 220° C., for a time sufficient to cure said mixture.

2. The method of claim 1, wherein the impregnation in step (iii) is achieved using a method selected from the group consisting of resin transfer molding, vacuum assisted resin transfer molding, liquid resin infusion, Seemann Composites Resin Infusion Molding Process, vacuum assisted resin infusion, injection molding, compression molding, spray molding, pultrusion, laminating and filament winding.

3. The method of claim 1, wherein the catalyst (c) is selected from the group consisting of aliphatic mono-, di- and polyamines, aromatic mono-, di- and polyamines, araliphatic mono-, di- and polyamines, carbocyclic mono-, di and polyamines, heterocyclic mono-, di- and polyamines, compounds containing a five- or six-membered nitrogen-containing heterocyclic ring, hydroxyamines, phosphines, phenols, and mixtures thereof.

4. The method of claim 3, wherein the catalyst (c) is selected from the group consisting of N,N-dimethyl-octylamine-boron trichloride complex, 2-ethyl-4-methylimidazole, 2-ethylimidazole, N,N-dimethyl-benzylamine, 2,4,6-tris(dimethylaminomethyl)phenol, 5-ethyl-2-methylpyridine, niacinamide, 1-butyl-3-methylpyridinium dicyanamide, and mixtures thereof.

5. The method of claim 3, wherein the catalyst (c) is selected from the group consisting of aromatic diamines of formula 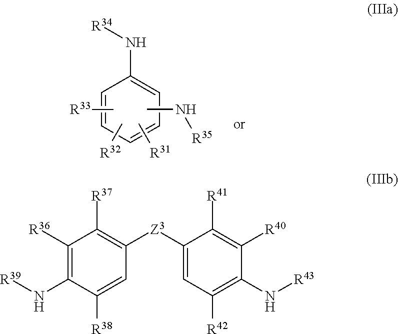
wherein R³¹, R³², R³³, R³⁶, R³⁶, R³⁷, R³⁸, R⁴⁰, R⁴¹ and R⁴² are independently selected from hydrogen, C₁₋₄ alkyl, C₁₋₄ alkoxy, C₁₋₄ alkylthio, and chlorine; R³⁴, R³⁵, R³⁹ and R⁴³ are independently selected from hydrogen and C₁₋₈ alkyl, and mixtures thereof; and Z³ indicates a direct bond or a divalent moiety selected from the group consisting of —O—, —S—, —S(═O)—, —S(═O)₂—, —CH(CF₃)—, —C(CF₃)₂—, —C(═O)—, —C(═CH₂)—, —C(═CCl₂)—, —Si(CH₃)₂—, linear C₁₋₁₀ alkanediyl, branched C₄₋₁₀ alkanediyl, C₃₋₈ cycloalkanediyl, 1,2-phenylene, 1,3-phenylene, 1,4-phenylene, and —N(R⁴⁴)- wherein R⁴⁴ is selected from the group consisting of hydrogen, linear C₁₋₁₀ alkyl, halogenated linear C₁₋₁₀ alkyl, branched C₄₋₁₀ alkyl, halogenated branched C₄₋₁₀ alkyl, C₃₋₈ cycloalkyl, phenyl and phenoxy,

6. The method of claim 5, wherein the catalyst (c) is selected from the group consisting of 3,5-diethyltoluene-2,4-diamine, 3,5-diethyltoluene-2,6-diamine, 3,5-bis(methylthio)toluene-2,4-diamine, 3,5-bis(methylthio)toluene-2,6-diamine, 4,4′-methylenebis(2,6-diisopropylaniline), 4,4′-methylenebis(2-isopropyl-6-methylaniline), 4,4′-methylenebis(2,6-diethylaniline), 4,4′-methylenebis(3-chloro-2,6-diethylaniline), 4,4′-methylenebis(2-ethyl-6-methylaniline), 4,4′-methylenebis(N-sec-butylaniline), and mixtures thereof.

7. The method of claim 1, wherein the at least one di- or polyfunctional cyanate ester (a) is a cyanate ester of formula (Ic) wherein R¹⁴ and R¹⁵ are hydrogen and the average value of n is from 1 to 20, preferably 1 to 5.

8. The method of claim 1, wherein the at least one di- or polyfunctional epoxy resin (b) is selected from the group consisting of bisohenol A diglycidyl ether resins, bisphenol F diglycidyl ether resins, N,N,O-triglycidyl-3-aminophenol, N,N,O-triglycidyl-4-aminophenol, N,N,N′,N′-tetraglycidyl-4,4′-methylenebisbenzenamine, 4,4′,4″-methylidenetrisphenol triglycidyl ether resins, naphthalenediol diglycidyl ethers, and mixtures thereof.

9. The method of claim 1, wherein the liquid mixture obtained in step (i) comprises from 20 to 80 wt. % of the at least one di- or polyfunctional cyanate ester (a).

10. The method of claim 1, wherein the liquid mixture obtained in step (i) comprises from 20 to 79 wt. % of the at least one di- or polyfunctional epoxy resin (b).

11. The method of claim 1, wherein the liquid mixture obtained in step (i) comprises from 0.1 to 10 wt. % of the catalyst (c).

12. The method of claim 1, wherein the liquid mixture obtained in step (i) comprises less than 20 wt. %, based on the total weight of the liquid mixture, of a solvent.

13. The method of claim 12, wherein the liquid mixture obtained in step (i) comprises less than 10 wt. %, based on the total weight of the liquid mixture, of a solvent.

14. The method of claim 13, wherein the liquid mixture obtained in step (i) is solvent-free.

15. The method of claim 1, wherein the fiber structure provided in step (ii) is selected from the group consisting of carbon fibers, glass fibers, quartz fibers, boron fibers, ceramic fibers, aramid fibers, polyester fibers, polyethylene fibers, natural fibers, and mixtures thereof.

16. The method of claim 1, wherein the fiber structure provided in step (ii) is selected from the group consisting of strands, yarns, rovings, unidirectional fabrics, 0/90° fabrics, woven fabrics, hybrid fabrics, multiaxial fabrics, chopped strand mats, tissues, braids, and combinations thereof.

17. The method of claim 1, wherein the liquid mixture obtained in step (i) comprises one or more additional components selected from the group consisting of mold release agents, fillers, reactive diluents, and combinations thereof.

18. A fiber-reinforced part obtainable by the method of claim 1.

19. The fiber-reinforced part of claim 18, being selected from the group consisting of fiber reinforced panels, complex geometries, parts with rotational symmetry parts, massive and hollow profiles, and sandwich-structured parts.
